(19) United States
(12) Patent Application Publication
(10) Pub. No.: US 2004/0223738 A1
(43) Pub. Date: Nov. 11, 2004

(54) User-defined categorized display of programs stored to video recording system

(76) Inventor: Carolynn Rae Johnson, Indianapolis, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/431,813

(22) Filed: May 7, 2003

(51) Int. Cl. H04N 5/76; G06F 3/00

(52) U.S. Cl. 386/83; 725/58

(57) ABSTRACT

There is provided a method for user-defined categorized display of programs stored to a video recording system. At least one user input is received that specifies at least one user-defined display category for at least one of the programs. Only program titles that correspond to a currently selected one of the at least one user-defined display category are displayed. A single copy of any of the programs is capable of simultaneously belonging to more than one user-defined display category.

### BACKGROUND OF THE INVENTION

1. Field of the Invention

The present invention generally relates to video recording systems and, more particularly, to a method and apparatus for user-defined categorized display of programs stored to a video recording system.

2. Background of the Invention

Personal Video Recording systems (PVRs) and Digital Video Recording systems (DVRs) allow the user to record programming to a Hard Disk Drive (HDD) for later playback. With the decreasing costs associated with digital storage, manufacturers are steadily increasing the size of the HDD associated with these devices.

While this increased storage space is very beneficial to the user, it can also make it more difficult for the user to find programs of interest that have been stored to the device, because the user interfaces of these devices can only display a small number of recorded program titles at any one time. Thus, the user must scroll through several screens to find programs of interest. This becomes especially problematic if multiple people in the household record programs to the HDD, as only a small percentage of the recorded programs may be of interest to the current user.

Many Electronic Program Guides (EPGs), such as those found in TVs and Digital Satellite System (DSS) receivers, allow the user to instruct the EPG to display only programs that match a predefined category. For example, the user can instruct the EPG to display only “Movies” or only “Sports”. Further, some EPGs allow the user to display, e.g., “Comedy Movies” or “Football”.

However, these display mechanisms are predefined by the broadcasters and cannot be edited by the user. Thus, instructing the video recording system to display only “Movies” would result in the display of all movies stored to the HDD, regardless of which user initially recorded that program and regardless of whether it is of interest to the current user. This sorting mechanism would also miss recorded programs that the current user might be interested in that are not classified as “movies”.

Accordingly, it would be desirable and highly advantageous to have a method and apparatus that allow a user to define “display categories” and to assign recorded programs to these display categories, so that the user will be better able to find programs of interest from among those recorded to the HDD.

### SUMMARY OF THE INVENTION

The problems stated above, as well as other related problems of the prior art, are solved by the present invention, a method and apparatus for user-defined categorized display of programs stored to a video recording system.

According to an aspect of the present invention, there is provided a method for user-defined categorized display of programs stored to a video recording system. At least one user input is received that specifies at least one user-defined display category for at least one of the programs. Only program titles that correspond to a currently selected one of the at least one user-defined display category are displayed. A single copy of any of the programs is capable of simultaneously belonging to more than one user-defined display category.

According to another aspect of the present invention, there is provided an apparatus for user-defined categorized display of programs stored to a video recording system. A display category manager receives at least one user input that specifies at least one user-defined display category for at least one of the programs. A display, coupled to said display category manager, displays only program titles-that correspond to a currently selected one of the at least one user-defined display category. The display manager is capable of permitting a single copy of any of the programs to simultaneously belong to more than one user-defined display category.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating a personal video recorder 100, according to an illustrative embodiment of the present invention;

FIG. 2 is a flow diagram illustrating a method for user-defined categorized display of video stored on a video recording system, according to an illustrative embodiment of the present invention;

FIG. 3 is a screen shot of a user interface element 300 (a define-display-category dialog box) that allows a user to create display categories without yet assigning the display categories to any programs, according to an illustrative embodiment of the present invention;

FIG. 4 is a screen shot of a user interface element 400 (define-display-category-for-unrecorded-program dialog box) that allows a user to assign a display category to a program to be recorded in the future, according to an illustrative embodiment of the present invention;

FIG. 5 is a screen shot of a user interface element 500 (define-display-category-for-recorded-program dialog box) that allow a user to assign a previously recorded program to a display category, according to an illustrative embodiment of the present invention;

FIG. 6 is a screen shot of the user interface element 500 shown in FIG. 5 where a drop down menu 510 of the user interface element 500 is fully opened, according to an illustrative embodiment of the present invention; and

FIG. 7 is a screen shot of the user interface 500 shown in FIG. 5 where the drop down menu 510 is fully opened and the programs corresponding to a user selected category are displayed, according to an illustrative embodiment of the present invention.

### DETAILED DESCRIPTION OF THE INVENTION

The present invention is directed to a method and apparatus for user-defined categorized display of programs stored to a video recording system. The present invention allows the user of a video recording system (e.g., a DVR, PVR, and so forth) to create “display categories” that would be used to present sub-lists of recorded programs stored to the hard drive. This would reduce the overall number of recorded programs displayed at any one time, making it easier for the user to find recorded programs that are of interest to him or her. Pop-up menus, banners, and/or other display structures (also referred to herein as “user interface elements”) may be used to allow the user to select a category for a program already recorded on the video recording system or for a program to be recorded in the future. The display structures may be displayed to the user at the time the user selects a program for recording, for playback, or at any other time. It is to be appreciated that as used herein the term “program” refers to any type and/or format of video that may be recorded to a memory device.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

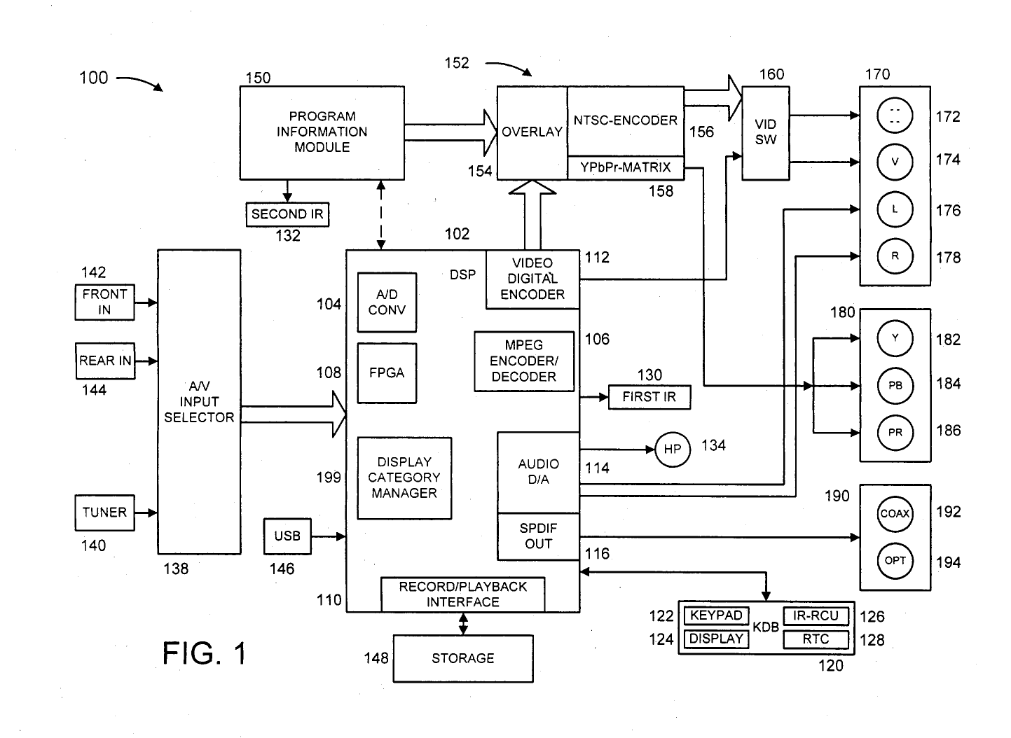

FIG. 1 is a block diagram illustrating a personal video recorder 100, according to an illustrative embodiment of the present invention. The personal video recorder (PVR) 100 can include a digital signal processor (DSP) 102, a key and display board (KDB) 120, a tuner 140, an A/V input selector 138, a USB input 146, a storage device 148, a program information module 150, and a display category manager 199. Additionally, the PVR 100 can include first and second infra-red (IR) links 130 and 132, a video overlay encoder 152, a video switch 160, a headphone jack 134, a standard A/V component connector block 170, a YPbPr component connector block 180, and a Sony/Phillips digital interface (SPDIF) connector block 190.

The component connector blocks 170, 180 and 190 can provide audio/video signals in a variety of output formats. For example, the standard A/V component connector block 170 can comprise an S-video connector 172 for outputting to a video display video that has been separated into chrominance and luminance video signals and a composite video connector 174 for providing a standard composite video signal. Further, the standard A/V component connector block 170 can comprise left and right audio output connectors, 176 and 178, respectively.

The YPbPr component connector block 180 is typically used for high definition television (HDTV). The YPbPr component connector block 180 comprises a video luminance (Y) output connector 182 for providing an analog video luminance component, a Pb output connector 184 for providing an analog blue color difference (B-Y), and a Pr output connector 186 for providing an analog red color difference (R-Y). Lastly, the SPDIF component connector block 190 comprises a coaxial output 192 and an optical output 194 for outputting digital audio signals via a coaxial cable or fiber optic cable, respectively.

The key and display board 120 can be provided as a user interface for the PVR 100 and can incorporate a keypad 122, a display 124, an IR remote control interface 126 and a real time clock 128. By using the keypad 122 or the IR remote control interface 126, a user can select functions to be executed by the PVR 100. For example, a user can choose to change channels on the PVR 100 or to perform trick mode playback. The real time clock 128 can keep time, which can be shown by the display 124. The display 124 also can show other information as well, for example a trick mode being executed by the PVR 100, a selected channel being recorded by the PVR 100, or an identifier representative of a presentation being shown on a video display.

First and second IR links 130 and 132 form a set of communication links between satellite and non-satellite applications to help simplify the interface between the audio, video, and data streams. The first IR link 130 can be a communication interface between the DSP 102 and other devices having an IR communication link. Notably, the first IR link 130 can be useful for controlling other devices designed specifically for aired or cable television broadcasts or radio broadcasts using standard program guide information. The first IR link 130 also can enable features to simplify the consumer's interaction between devices. For example, the first IR link 130 can enable one touch program recording, as well as other user conveniences. The second IR link 132 can provide an interface between the program information module 150 and other devices having IR communication links. Significantly, the second IR link 132 can be useful for communicating with devices not requiring a direct connection to DSP 102, for example with a cable reception device, a VCR, and so forth.

The DSP 102 can comprise an analog to digital (A/D) converter 104, an MPEG encoder/decoder 106, a field programmable gate array (FPGA) 108, a record/playback interface 110, a video digital encoder 112, an audio digital to analog converter (audio D/A) 114 and a SPDIF output 116. The DSP 102 can further include one or more data busses enabling the different DSP components to communicate with each other and cooperatively process data. Notably, interrupt requests (IRQs) and direct memory addresses (DMAs) can be utilized to facilitate bus communications and data processing.

AudioNideo (A/V) input selector 138 can include a plurality of A/V inputs. For example, the AN input selector 138 can incorporate an AN input to receive AN signals from tuner 140. The A/V input selector 138 also can receive signals form various other input devices as well. For example, a video camera can send A/V signals to the A/V input selector 138 via front AN input 142, and a VCR can send AN signals via rear AN input 144. Significantly, other A/V devices can be connected to the AN input selector 138 as well.

The AN input selector 138 can forward the received A/V signals to DSP 102. The DSP's A/D converter 104 can be used to convert AN signals received in an analog format to a digital format. AN signals already in digital format can bypass the analog to digital conversion, for example, digital signals received via a universal serial bus (USB) interface 146.

FPGA 108 can provide processing instructions for data received from the AN input selector 138 or the USB interface 146, depending on the type of data received. For example, if AN data is received in an uncompressed form, FPGA 108 can forward the A/V data to MPEG encoder/decoder 106 for MPEG compression prior to being sent to the record/playback interface 110. However, if AN data is received in an MPEG compressed format, FPGA 108 can forward the AN data straight to the receive/playback interface 110. In either case the FPGA 108 can provide read/write instructions to the record/playback interface 110, which then can store the AN data onto storage 148.

MPEG encoder/decoder 106 can perform MPEG compression and decompression on digital A/V signals. For example, MPEG encoder/decoder 106 can receive digital AN signals from A/D converter 104 or USB interface 146, compress the digital AN signals using an MPEG format, and forward the compressed digital AN signals to the receive/playback interface 110. The record/playback interface 110 then can store the compressed digital AN signals to storage 148.

Storage 148 can include one or more data storage devices. For example, a data storage device can be a magnetic storage medium, such as a hard disk drive (HDD), an optical storage medium, such as a digital video disk (DVD), an electronic storage medium, such as random access memory (RAM), a magneto/optical storage medium, or any combination of storage devices.

During playback the record/playback interface 110 can read A/V data from storage 148. The AN data then can be forwarded to MPEG encoder/decoder 106 for decompression. After decompression the A/V data can be separated into video and audio signals. The audio signal can be forwarded to SPDIF 116 to be output digitally via coaxial output 192 or optical output 194. The audio signal also can be forwarded to audio D/A converter 114 for D/A conversion. After D/A conversion the audio signal can be output via headphone jack 134 and/or left and right audio outputs 176 and 178.

The video signal can be processed by video digital encoder 112, which can perform D/A conversion on the video signal as well as encode the video signal into a variety formats. For example, the video signal can be encoded into an RGB format, separated into luminance and chrominance (Y+C) signals, or encoded into a composite video signal having a National Television Standards Committee (NTSC) format. The composite video and the Y+C video signals can be forwarded to video switch 160, while the RGB video signal can be forwarded to the video overlay encoder 152.

The video overlay encoder 152 can include overlay module 154, NTSC video encoder 156, and YPbPr matrix encoder 158. The overlay module 154 can receive program information from a program information module 150 and graphically overlay the program information onto the video signal. The program information module 150 can extract the program information from an on-line program guide or a program guide contained in incoming AN signals received by the AN input selector 138 and communicated to the program information module 150 by the DSP 102. The program information can include available programs for each channel as well as program scheduling. Further, for each individual program the program information can include a program identifier, channel information, recording time, program duration, scene data, program credits, and so forth. Other information and graphics may be overlayed onto the video signal as well. For example, a clock, text blocks, user information, menus, icons, pictures, etc. can be overlayed onto the video signal. Typically, information is overlayed onto the video signal when requested by a user or upon some pre-defined event. However, some information, such as a channel identifier, can be continually overlayed over the video signal.

The NTSC video encoder 156 can output the video signal as an NTSC formatted composite video signal, as well as video separated into separate luminance and chrominance signals. The video signals then can be forwarded to the video switch 160. The video switch 160 can be used to select for display either the NTSC encoded video signal or the video signal generated by the video digital encoder 112. Composite video signals from either source can be output via composite video output connector 174, while chrominance and luminance video signals from either source can be output via the S-video output connector 172.

The YPbPr matrix encoder 158 can generate a YPbPr formatted analog video signal. As previously noted, the YPbPr video signal includes a video luminance (Y) component, an analog blue color difference (B-Y), and an analog red color difference (R-Y). The Y component can be output to the Y output connector 182, the (B-Y) difference can be output to the Pb output connector 184 and the (R-Y) difference can be output to the Pr output connector 186.

The display category manager 199 is capable of creating and managing user-defined display categories. It is to be appreciated that in some embodiments of the present invention, some or all of the functions performed by the display category manager 199 may be subsumed by other elements of the PVR 100. For example, DSP 102 and computer programming code stored in storage device 148 may be used to implement the functions performed by the display category manager 199. Moreover, other elements, as readily contemplated by one of ordinary skill in the related art, may be used to implement those functions. Given the teachings of the present invention provided herein, one of ordinary skill in the related art will contemplate these and various other implementations and configurations of the present invention, while maintaining the spirit and scope of the present invention.

Advantageously, the present invention provides a user of a PVR 100 or other video recording system with the capability to define a new category for use in displaying programs stored on the Hard Disk Drive (HDD) of the PVR 100. In an illustrative embodiment of the present invention, the present invention provides this capability from within the user interface of the PVR. For example, the capability may be accessed from the device's main menu, from an informational banner, from a recorded programs guide, or from any other part of the user interface. Of course, the present invention is not limited to providing the capability solely from the user interface of the PVR and, thus, other configurations and implementations may be employed while maintaining the spirit and scope of the present invention.

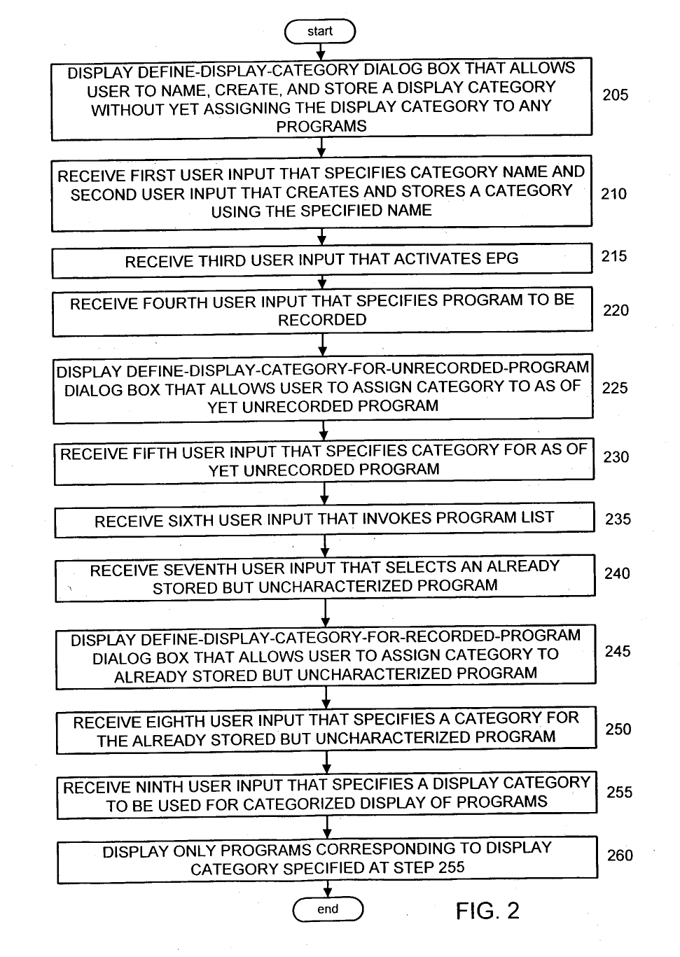

FIG. 2 is a flow diagram illustrating a method for user-defined categorized display of video stored on a video recording system, according to an illustrative embodiment of the present invention.

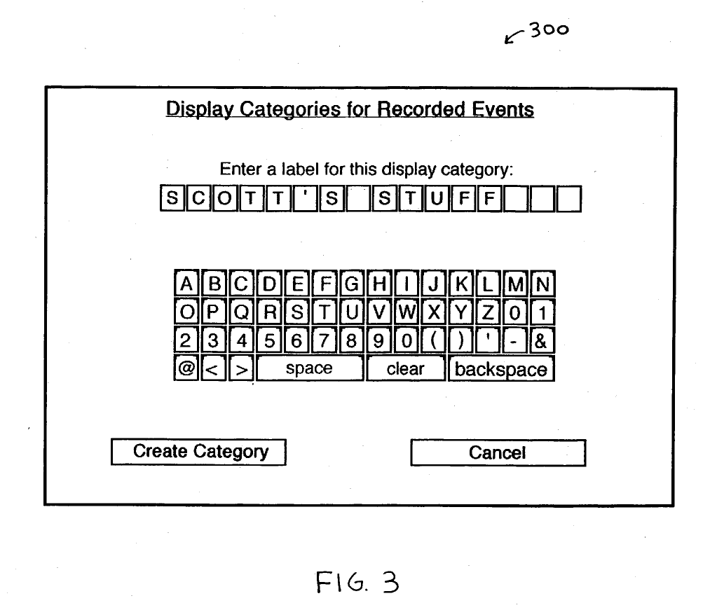

Upon selecting a “categorized display” feature by a user of the video recording system, a define-display-category dialog box is displayed that allows the user to name, create, and store a category without yet assigning the category to any programs (step 205). The category, once assigned at a later time to one or more programs, is used to sort the programs for display purposes. FIG. 3 is a screen shot of a user interface element 300 (a define-display-category dialog box) that allows a user to create display categories without yet assigning the display categories to any programs, according to an illustrative embodiment of the present invention.

A first user input is received that specifies a category name and a second user input is received that creates and stores a category using the specified name (step 210).

It is to be appreciated that once at least one category had been created, the user would have the ability to assign that category to a program that will be recorded at a future time or to a program that has already been recorded and stored to the HDD.

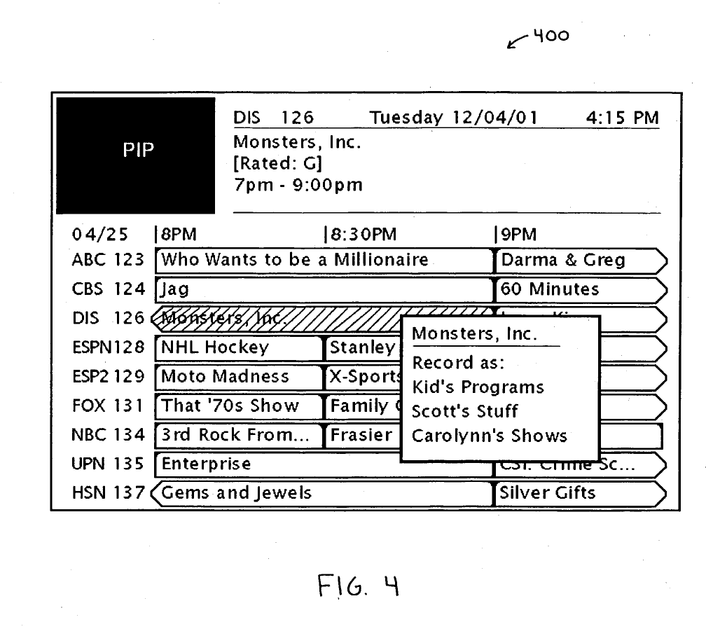

Thus, if the user intends to record a program in the future using an Electronic Program Guide (EPG), a third user input is received that activates the EPG (step 215), a fourth user input is received that specifies the program to be recorded in the future (hereinafter “program to be recorded”) (step 220), and a define-display-category-for-unrecorded-program dialog box is displayed to the user that allows the user to assign a category to the program to be recorded (step 225). Accordingly, a fifth user input is received that specifies a category for the program to be recorded (step 230). A visual indication is provided to indicate which program listed in the EPG has been selected for recording; in the example of FIG. 4 below, such visual indication is a visual pattern (diagonal parallel lines) applied over the name of the selected program.

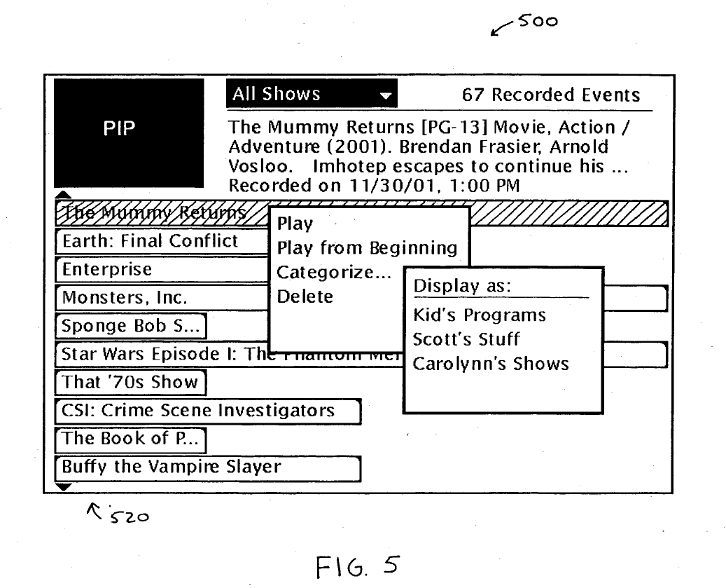

FIG. 4 is a screen shot of a user interface element 400 (define-display-category-for-unrecorded-program dialog box) that allows a user to assign a display category to a program to be recorded in the future, according to an illustrative embodiment of the present invention. Thus, when the user selects a program to be recorded in the EPG, a pop-up menu or other display structure may be displayed that allows the user to select a display category for that program. In the example of FIG. 5 described below, the user has previously created three categories: “Kid's Programs”, “Scott's Stuff” and “Carolynn's Shows”. In this case, the user might want to categorize the to-be-recorded program, “Monsters, Inc.” as “Kid's Programs”. Once recorded, “Monsters, Inc.” would then be displayed anytime the user specified that “Kid's Programs” should be displayed.

FIG. 5 is a screen shot of a user interface element 500 (define-display-category-for-recorded-program dialog box) that allow a user to assign a previously recorded program to a display category, according to an illustrative embodiment of the present invention. The user interface 500 includes a recorded events program list 520. If the user intends to categorize a program already recorded and stored to the HDD that has not yet been categorized, a sixth user input may be received that invokes a program list (step 235), and upon the receipt of a seventh user input that selects an already stored but as-of-yet uncharacterized program (step 240), a define-display-category-for-recorded-program dialog box is displayed to the user that allows the user to assign a category to the already recorded program (step 245). Accordingly, an eighth user input is received that specifies a category to the already recorded program (step 250).

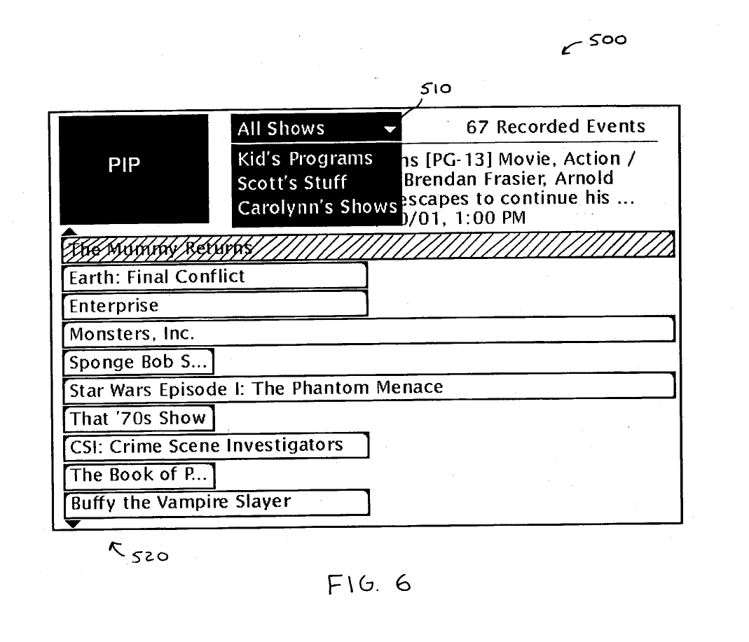

FIG. 6 is a screen shot of the user interface element 500 shown in FIG. 5 where a drop down menu 510 of the user interface element 500 is fully opened, according to an illustrative embodiment of the present invention. The recorded events program list 520 lists all of the programs that have been recorded and stored to the HDD, as can be seen by the label “All Shows” on the drop-down menu 510 at the top of the dialog box 500. In the example, the drop-down menu 510 functions as a user interface control element which, when selected, allows the user to specify that a subset of the programs should be displayed (as can be seen in FIG. 6).

In the example of FIG. 6, selecting the label “All Shows” presents the user with a drop down menu of all display categories that have been defined by the user. Selecting one of the display categories in this menu would then result in the displaying to the user of only those recorded programs that have been assigned to that display category.

A ninth user input is received that specifies a display category to be used for a categorized display of the programs on the video recording system (step 255). Only programs corresponding to the display category specified at step 255 are displayed to the user, in response to the ninth user input (step 260).

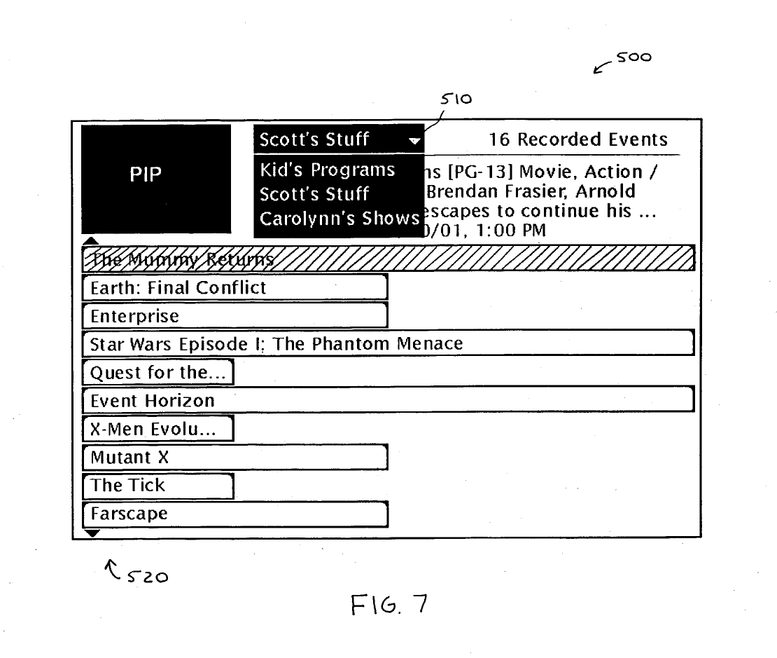

FIG. 7 is a screen shot of the user interface 500 shown in FIG. 5 where the drop down menu 510 is fully opened and the programs corresponding to a user selected category are displayed, according to an illustrative embodiment of the present invention. In the example of FIG. 7, the user has specified that the list “Scott's Stuff” should be displayed. Thus, the overall number of programs presented to the user has been reduced from a list of 67 programs (where “all shows” were listed, as depicted in FIG. 6) to a list of 16 programs (where only the programs corresponding to the category “Scott's Stuff” are listed, as depicted in FIG. 7), and the user can more quickly find programs of interest.

It is to be appreciated that while the present invention is described herein with respect to banners, menus, dialog boxes, and so forth, the present invention is not limited to these display structures (also referred to as “user interface elements”) and, thus, other structures and the like as readily contemplated by one of ordinary skill in the related art may be employed in implementations of the present invention, while maintaining the spirit and scope of the present invention. The other structures may be, e.g., other display structures (e.g., menus, dialog, boxes, etc.), hardware structures (e.g., switches, buttons, sliders, etc.), and so forth.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for user-defined categorized display of programs stored to a video recording system, comprising the steps of:
receiving at least one user input that specifies at least one user-defined display category for at least one of the programs; and
displaying only program titles that correspond to a currently selected one of the at least one user-defined display category,
wherein a single copy of any of the programs is capable of simultaneously belonging to more than one user-defined display category.

2. The method of claim 1, further comprising the steps of:
creating the at least one user-defined display category in response to the at least one user input; and
storing the at least one user-defined display category on the video recording system for future reference.

3. The method of claim 1, wherein at least one of the at least one of the programs is yet to be recorded on the video recording system.

4. The method of claim 1, further comprising the step of providing a user of the video recording system with a capability to create display categories without yet assigning the display categories to any of the programs.

5. The method of claim 1, further comprising the step of providing a user of the video recording system with a capability to assign a display category to a program to be recorded in the future.

6. The method of claim 1, further comprising the step of providing a user of the video recording system with a capability to assign a previously recorded program to a display category.

7. The method of claim 1, further comprising the step of displaying a user interface element for receiving user inputs to create display categories without yet assigning the display categories to any of the programs.

8. The method of claim 1, further comprising the step of displaying a user interface element for receiving user inputs to assign a display category to a program to be recorded in the future.

9. The method of claim 1, further comprising the step of displaying a user interface element for receiving user inputs to assign a previously recorded program to a display category.

10. The method of claim 1, wherein the at least one user-defined display category corresponds to at least one of a plurality of users of the video recording system.

11. An apparatus for user-defined categorized display of programs stored to a video recording system, comprising:
a display category manager for receiving at least one user input that specifies at least one user-defined display category for at least one of the programs; and
a display, coupled to said display category manager, for displaying only program titles that correspond to a currently selected one of the at least one user-defined display category,
wherein said display manager is capable of permitting a single copy of any of the programs to simultaneously belong to more than one user-defined display category.

12. The apparatus of claim 11, wherein said display category manager is adapted to create the at least one user-defined display category in response to the at least one user input, and said apparatus further comprises a memory device for storing the at least one user-defined display category on the video recording system for future reference.

13. The apparatus of claim 11, wherein at least one of the at least one program is yet to be recorded on the video recording system.

14. The apparatus of claim 11, further comprising a user interface for initially receiving the at least one user input from a user and for forwarding the at least one user input to the display category manager.

15. The apparatus of claim 11, wherein said user interface comprises a user interface element for receiving user inputs to create display categories without yet assigning the display categories to any of the programs.

16. The apparatus of claim 11, wherein said user interface comprises a user interface element for receiving user inputs to assign a display category to a program to be recorded in the future.

17. The apparatus of claim 11, wherein said user interface comprises a user interface element for receiving user inputs to assign a previously recorded program to a display category.

18. The apparatus of claim 11, wherein the at least one user-defined display category corresponds to at least one of a plurality of users of the video recording system.
